(19) United States
(12) Patent Application Publication
(10) Pub. No.: US 2011/0065016 A1
(43) Pub. Date: Mar. 17, 2011

(54) FUEL CELL AND FUEL CELL LAYER

(76) Inventors: Shunsuke Sata, Osaka (JP); Toshiyuki Fujita, Osaka (JP); Tomohisa Yoshie, Osaka (JP); Yoshihiro Tsukuda, Osaka (JP); Hironori Kambara, Osaka (JP); Chikaaki Kogure, Osaka (JP)

(21) Appl. No.: 12/992,467

(22) PCT Filed: May 12, 2009
(86) PCT No.: PCT/JP2009/058816

§ 371 Date: Nov. 12, 2010

(30) Foreign Application Priority Data
May 13, 2008 (JP) 2008126380

(51) Int. Cl. H01M 8/24; H01M 2/02

(52) U.S. Cl. 429/469; 429/508

(57) ABSTRACT

There is provided a fuel cell including a membrane electrode assembly having a cathode electrode, an electrolyte membrane, and an anode electrode in this order, and an anode collector layer. The anode collector layer includes a pair of first walls provided along two opposite sides. The membrane electrode assembly is fitted between the first walls such that the anode electrode faces the anode collector layer. A fuel cell layer employing the fuel cells is also provided. Preferably, the fuel cell further includes a pair of second walls formed on the pair of first walls.

### TECHNICAL FIELD

The present invention relates to a fuel cell and a fuel cell layer.

### BACKGROUND ART

For the power source of portable electronic devices and the like that support the information society, the expectation for a fuel cell is increasing in recent years in view of the high power generation efficiency and high energy density as a unitary power generation device. A fuel cell is based on electrochemical reaction including oxidation of a reductant (for example, methane gas, hydrogen, methanol, ethanol, hydrazine, formalin, formic acid, or the like) at an anode electrode, and reduction of an oxidant (for example, the oxygen in the air, hydrogen peroxide, or the like) at a cathode electrode, generating electrical energy through the reaction.

Particularly, a direct methanol fuel cell (DMFC) utilizing methanol as the reductant does not require a reformer, and uses liquid fuel having a higher volume energy density than gaseous fuel. This provides the advantage that the fuel container can be reduced in size as compared to the case where a high-pressure gas cylinder typical of hydrogen is used. Therefore, a DMFC is suitably applicable in the usage of replacing a power source directed to small equipment, particularly a secondary battery for portable equipment.

Further, a DMFC allows the narrow and curved space that is dead space in a conventional fuel cell system to be used as a fuel storage space by virtue of the fuel being a liquid, providing the advantage that the design is not readily susceptible to restriction. This advantage facilitates the preferable application of the DMFC to portable small electronic equipment and the like.

Generally in a DMFC, a reaction set forth below occurs at the anode electrode and cathode electrode. At the anode electrode side, methanol and water react to generate carbon dioxide gas, protons, and electrons. At the cathode electrode side, the oxygen in the air, protons and electrons react to generate water.

CH₃OH+H₂O→CO₂+6H⁺+6e⁻ Anode electrode

O₂+4H⁺+4e⁻→2H₂O Cathode electrode

However, a DMFC conventionally has a low output per volume. It is desirable to improve the output per volume in view of reducing the size and weight of a fuel cell.

In general, a conventional fuel cell such as a polymer electrolyte fuel cell, a solid oxide fuel cell, a direct methanol fuel cell (DMFC), and an alkaline fuel cell is configured of the stacked layers including an anode separator having a fuel flow channel to supply a reductant; an anode collector and an anode gas diffusion layer for collecting electrons from an anode catalyst layer; the anode catalyst layer for promoting a reduction reaction; an electrolyte membrane for maintaining electrical insulation and for transmitting ions in precedence; a cathode catalyst layer for promoting an oxidation reaction; a cathode collector for supplying electrons to a cathode gas diffusion layer and the cathode catalyst layer; and a cathode separator having an air flow channel to supply an oxidant, in this order.

The anode separator and cathode separator generally serve to supply a reductant and an oxidant individually to the anode catalyst layer and the cathode catalyst layer, respectively, and also function as an anode collector and a cathode collector, respectively, using electrically conductive material. Based on the fact that the voltage of each unit fuel cell is low, a fuel cell is typically configured as a fuel cell stack capable of high voltage output, having stacked unit fuel cells such that an anode electrode and a cathode electrode of each unit fuel cell are brought into contact alternately.

In such a layered fuel cell stack, close electrical contact between respective layers must be maintained. If the contact resistance therebetween is increased, the internal resistance of the fuel cell will become higher to reduce the overall power generation efficiency. Further, a fuel cell stack generally has a sealing member in each fuel cell to prevent leakage of the reductant and oxidant. In order to ensure sufficient sealing and electrical conductance, each layer conventionally has to be constricted by a strong force. This induces the need of a fastening member such as a pressing plate, bolt, nut or the like to constrict each layer, leading to the problem that the fuel cell stack is increased in size and weight, and reduced in output density.

For example, Japanese Patent Laying-Open No. 2006-216449 (Patent Document 1) discloses a fuel cell including an anode catalyst layer and a cathode catalyst layer, and an anode diffusion layer and a cathode diffusion layer, stacked at either side of a solid electrolyte membrane, and an anode hydrophobic insulation layer and a cathode hydrophobic insulation layer, formed around the catalyst layers and diffusion layers, wherein the thicknesses of the anode hydrophobic insulation layer and the cathode hydrophobic insulation layer are less than or equal to the total thickness of the anode catalyst layer and the anode diffusion layer, and the total thickness of the cathode catalyst layer and the cathode diffusion layer, respectively.

Further, a general fuel cell has sealing members sandwiching a membrane electrode assembly formed of an anode, a solid electrolyte membrane, and a cathode, and the stacked body is further subject to pressure by means of a fastening member to improve the adherence between the layered members (for example, refer to Japanese Patent Laying-Open No. 2006-269126 (Patent Document 2)).

Moreover, as a fuel cell directed to reducing the size and weight, there is proposed a configuration that does not use a fastening member and that does not sandwich the solid electrolyte membrane with a sealing member such as a hydrophobic insulation layer while the membrane electrode assembly as well as a fuel supplying part and a cathode side separator constitute the same cross section at the side face of the fuel cell, which is sealed by a sealing member in order to prevent fuel leakage and oxidant leakage from each contacting face.

### PRIOR ART DOCUMENTS

### Patent Documents

Patent Document 1: Japanese Patent Laying-Open No. 2006-216449

Patent Document 2: Japanese Patent Laying-Open No. 2006-269126

### SUMMARY OF THE INVENTION

### Problems to be Solved by the Invention

The fuel cell of Patent Document 1 does not have a fastening member constricting the fuel cell from the anode side and cathode side. Therefore, although the fuel cell stack is reduced in size and weight, the adherence at the contacting face between a fuel supplying part and the anode hydrophobic insulation layer, between the anode hydrophobic insulation layer and the solid electrolyte membrane, between the solid electrolyte membrane and the cathode hydrophobic insulation layer, and between the cathode hydrophobic insulation layer and a cathode side separator is insufficient. Thus, there was a problem that a gap is generated at these contacting faces, leading to the leakage of fuel and oxidant from the contacting faces.

Further, a fuel cell employing a fastening member may have the solid electrolyte membrane damaged and fractured by the contact with the sealing member caused by the intense constriction due to its thin thickness, leading to the problem of difficulty in supplying power stably to portable electronic equipment and the like.

Moreover, in the case where a fuel cell layer is configured having a plurality of fuel cells disposed apart, the gap region between adjacent fuel cells will be partially occupied by the sealing member. Therefore, there is a problem that it is difficult to form a sealing layer of high dimension accuracy. Thus, it is difficult to ensure a gap region of high dimension accuracy, leading to the problem of reduction in the diffusion region of the oxidant.

The present invention is directed to solving the problem set forth above. An object of the present invention is to provide a fuel cell and a fuel cell layer allowing fuel leakage and oxidant leakage to be suppressed without using a fastening member.

### Means for Solving the Problems

The present invention provides a fuel cell including a membrane electrode assembly having a cathode electrode, an electrolyte membrane and an anode electrode in this order, and an anode collector layer. The anode collector layer includes a pair of first walls provided along two opposite sides. The membrane electrode assembly is fitted between the paired first walls such that the anode electrode faces the anode collector layer.

Preferably, the fuel cell of the present invention further includes a pair of second walls formed on the pair of first walls. Preferably, there is a gap space between the membrane electrode assembly and the second walls. Preferably, the gap space is filled with an insulative sealant to form an insulative sealant layer.

A side face of the membrane electrode assembly and a side face of the second wall facing the membrane electrode assembly may be substantially parallel. Further, the side face of the second wall facing the membrane electrode assembly may be inclined relative to the side face of the membrane electrode assembly. Moreover, the side face of the second wall facing the membrane electrode assembly may have a recess and a projection. The second wall is preferably formed of an electrically insulative material.

In the present invention, the second wall may be a layer formed of a porous material including an insulative sealant, arranged to form contact with the side face of the membrane electrode assembly. The second wall is preferably formed integrally with the anode collector layer.

The present invention also provides a fuel cell layer having a plurality of the fuel cells set forth above disposed with a gap region.

### EFFECTS OF THE INVENTION

According to the present invention, there can be provided a fuel cell and a fuel cell layer absent of fuel leakage and oxidant leakage, without using a fastening member.

### BRIEF DESCRIPTION OF THE DRAWINGS

FIG. 1 is a sectional view schematically representing a preferable example of a fuel cell of the present invention.

FIG. 2 is a sectional view schematically representing another preferable example of a fuel cell of the present invention.

FIG. 3 is a sectional view schematically representing a further preferable example of a fuel cell of the present invention.

FIG. 4 is a sectional view schematically representing a further preferable example of a fuel cell of the present invention.

FIG. 5 is a sectional view of a fuel cell produced in Example 1.

FIG. 6 is a sectional view of a fuel cell produced in Comparative Example 1.

### MODES FOR CARRYING OUT THE INVENTION

Embodiments of a fuel cell and a fuel cell layer of the present invention will be described in detail hereinafter. The embodiments set forth below are all directed to a direct methanol fuel cell (DMFC) generating power by extracting protons directly from methanol. A methanol solution is used as a fuel, whereas air (specifically, the oxygen in the air) is used as an oxidant.

### First Embodiment

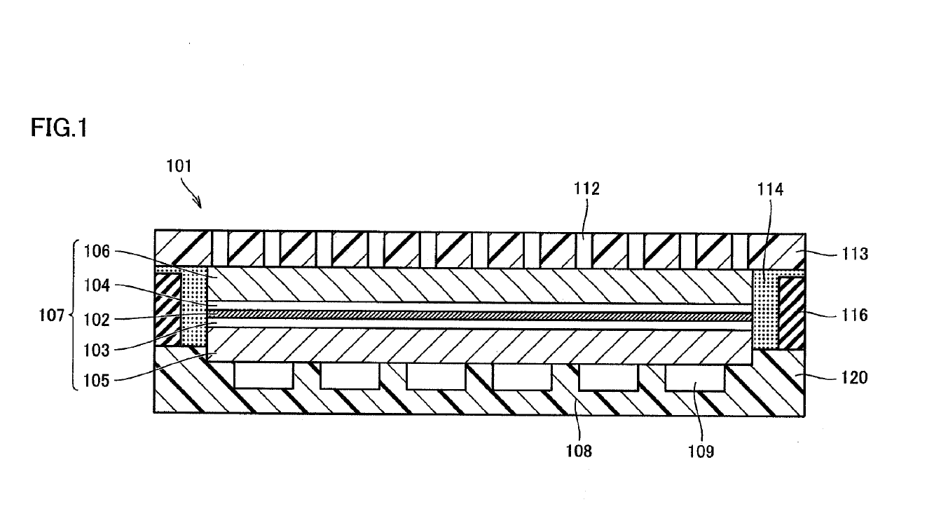

FIG. 1 is a sectional view schematically representing a preferable example of a fuel cell of the present invention. A fuel cell 101 shown in FIG. 1 includes a membrane electrode assembly 107 consisting of an electrolyte membrane 102, an anode catalyst layer 103 arranged at one surface of electrolyte membrane 102, a cathode catalyst layer 104 arranged at the other surface of electrolyte membrane 102, an anode gas diffusion layer 105 arranged in contact with a surface of anode catalyst layer 103 opposite to the surface meeting electrolyte membrane 102, and a cathode gas diffusion layer 106 arranged in contact with a surface of cathode catalyst layer 104 opposite to the surface meeting electrolyte membrane 102. Cathode catalyst layer 104 and cathode gas diffusion layer 106 constitute a cathode electrode. Anode catalyst layer 103 and anode gas diffusion layer 105 constitute an anode electrode. An anode collector layer 108 is provided in contact with a surface of anode gas diffusion layer 105 opposite to the surface meeting anode catalyst layer 103. Anode collector layer 108 has a fuel flow channel 109 that is the space for fuel transportation. Further, a cathode collector layer 113 is stacked in contact with a surface of cathode gas diffusion layer 106 opposite to the surface meeting cathode catalyst layer 104. Cathode collector layer 113 has a through hole 112 to introduce air to the cathode electrode.

The fuel cell of the present embodiment includes the anode gas diffusion layer and the cathode gas diffusion layer. In the case where oxygen in the air is supplied uniformly to the cathode catalyst layer, and fuel is supplied uniformly to the anode catalyst layer, the anode gas diffusion layer and the cathode gas diffusion layer are dispensable. One or both of the anode gas diffusion layer and the cathode gas diffusion layer may be omitted.

Fuel cell 101 also includes an insulative sealing layer 114 formed at the side face of membrane electrode assembly 107, and a second wall 116 provided on anode collector layer 108 to cover membrane electrode assembly 107 and insulative sealing layer 114.

<Electrolyte Membrane>

The material for electrolyte membrane 102 is not particularly limited as long as it has proton conductivity and is electrically insulative. Preferably, the conventionally well-known appropriate polymer membrane, inorganic membrane, or composite membrane is employed. Examples of the polymer membrane include, for example, perfluorosulfonic acid based electrolyte membrane (NAFION (registered trademark) from E.I. du Pont de Nemours & Co.), a Dow membrane (registered trademark, from Dow Chemical Company), ACIPLEX (registered trademark, from Asahi Kasei Corporation), Flemion (registered trademark, from Asahi Glass Co., Ltd.), as well as a hydrocarbon based electrolyte membrane such as of polystyrene sulfonic acid, sulfonated polyether ether ketone, and the like. Examples of the inorganic membrane include, for example, membranes of phosphate glass, cesium hydrogen sulfate, polytungstophosphoric acid, ammonium polyphosphate, and the like. Examples of the composite membrane include, a GORE-SELECT membrane (GORE-SELECT (registered trademark): by W.L. Gore & Associates Inc.).

In the case where the fuel cell attains a temperature in the vicinity of or above 100° C., the electrolyte membrane is preferably composed of a material having high ion conductivity even in a low moisture content such as sulfonated polyimide, 2-acrylamido-2-methylpropane sulfonic acid (AMPS), sulfonated polybenzimidazole, phosphonated polybenzimidazole, cesium hydrogen sulfate, ammonium polyphosphate, ionic liquid (ambient temperature molten salt) or the like.

The proton conductivity of the electrolyte membrane is preferably greater than or equal to 10⁻⁵ S/cm. More preferably, a polymer electrolyte membrane having a proton conductivity greater than or equal to 10⁻³ S/cm such as of perfluorosulfonic acid polymer, a hydrocarbon based polymer or the like is used.

<Anode Catalyst Layer and Cathode Catalyst Layer>

Anode catalyst layer 103 includes a catalyst promoting oxidation of the fuel. By causing oxidation reaction of the fuel on the catalyst, protons and electrons are generated. Cathode catalyst layer 104 includes a catalyst promoting reduction of the oxidant. The oxidant combines with the protons and electrons on the catalyst to cause reduction reaction.

For the aforementioned anode catalyst layer 103 and cathode catalyst layer 104, a layer including a catalyst-supported carrier and an electrolyte, for example, may be employed. In this case, the anode catalyst in anode catalyst layer 103 functions to promote the reaction rate of generating protons and electrons from, for example, methanol and water. The electrolyte functions to transport the generated protons to the electrolyte membrane. The anode carrier functions to conduct the generated electrons to the anode gas diffusion layer. In cathode catalyst layer 104, the cathode catalyst functions to promote the reaction rate of generating water from oxygen, protons, and electrons. The electrolyte functions to transport protons from the electrolyte membrane to the proximity of the cathode catalyst. The cathode carrier functions to conduct electrons to the cathode catalyst from cathode gas diffusion layer 106.

The anode carrier and the cathode carrier are capable of conducting electrons and the catalyst also has electron conductivity. Therefore, anode catalyst layer 103 and cathode catalyst layer 104 do not necessarily have to include a carrier. In this case, supply or reception of electrons to/from anode gas diffusion layer 105 or cathode gas diffusion layer 106 is effected by the anode catalyst or cathode catalyst, respectively.

Examples of the anode catalyst and the cathode catalyst include a noble metal such as Pt, Ru, Au, Ag, Rh, Pd, Os and Ir; a base metal such as Ni, V, Ti, Co, Mo, Fe, Cu, Zn, Sn, W and Zr; an oxide, a carbide, and a carbonitride of the noble metal or the base metal; and carbon. The material set forth above may be employed singularly or in combination of two or more types as the catalyst. The anode catalyst and the cathode catalyst may be of the same or different type of catalyst.

For the carrier employed in anode catalyst layer 103 and cathode catalyst layer 104, a carbon based material having high electrical conductivity is preferable. Such carbon based material includes, for example, acetylene black, Ketchen black (registered trademark), amorphous carbon, carbon nanotube, carbon nanohorn and the like. In addition to such carbon based materials, a noble metal such as Pt, Ru, Au, Ag, Rh, Pd, Os and Ir; a base metal such as Ni, V, Ti, Co, Mo, Fe, Cu, Zn, Sn, W and Zr; an oxide, a carbide, a nitride, and a carbonitride of the noble metal or the base metal can be enumerated. The material set forth above may be employed singularly or in combination of two or more types as the carrier. Further, a material having proton conductivity, specifically sulfated zirconia, zirconium phosphate, and the like may be employed for the carrier.

Although the material of the electrolyte employed in anode catalyst layer 103 and cathode catalyst layer 104 is not particularly limited as long as it has proton conductivity and electrically insulative, a solid or gel not dissolved by methanol is preferable. Specifically, for the material of the electrolyte, organic polymer having a strong acid group such as sulfonic acid group and phosphoric acid group or a weak acid group such as carboxyl group is preferable. Examples of such organic polymer include sulfonic acid group containing perfluorocarbon (NAFION (registered trademark), from E.I. du Pont de Nemours & Co.), carboxyl group containing perfluorocarbon (Flemion (registered trademark): from Asahi Kasei Corporation), polystyrene sulfonic acid copolymer, polyvinyl sulfonic acid copolymer, ionic liquid (ambient temperature molten salt), sulfonated imide, 2-acrylamido-2-methylpropane sulfonic acid (AMPS), and the like. In the case where the aforementioned carrier provided with proton conductivity is used, anode catalyst layer 103 and cathode catalyst layer do not necessarily have to include the electrolyte since the carrier has proton conductivity.

A thickness of anode catalyst layer 103 and cathode catalyst layer 104 is preferably set less than or equal to 0.5 mm in order to reduce the resistance in proton conduction and electron conduction, as well as to reduce diffusion resistance in the fuel (for example, methanol) or the oxidant (for example, oxygen). Further, the thickness of anode catalyst layer 103 and cathode catalyst layer 104 is preferably at least 0.1 μm since sufficient amount of catalyst must be carried to improve the output as a cell.

<Anode Gas Diffusion Layer and Cathode Gas Diffusion Layer>

Anode gas diffusion layer 105 and cathode gas diffusion layer 106 are preferably formed of an electrically conductive porous body. For example, carbon paper, carbon cloth, metallic foam, sintered metal, nonwoven fabric of metal fiber, and the like can be employed.

A porosity of cathode gas diffusion layer 106 is preferably greater than or equal to 30% in order to reduce oxygen diffusion resistance, and preferably less than or equal to 95% in order to reduce the electrical resistance. More preferably, the porosity is 50 to 85%. A thickness of cathode gas diffusion layer 106 is preferably greater than or equal to 10 μm in order to reduce oxygen diffusion resistance in a direction perpendicular to the stacked direction of cathode gas diffusion layer 106, and preferably less than or equal to 1 mm in order to reduce oxygen diffusion resistance in the stacked direction of cathode gas diffusion layer 106. More preferably, the thickness is 100 to 500 μm.

<Anode Collector Layer>

Anode collector layer 108 is provided adjacent to anode gas diffusion layer 105, and functions to transmit/receive electrons to/from anode gas diffusion layer 105. In the present invention, one or more fuel flow channels 109 are formed at the anode collector layer. Examples of a suitable material employed for anode collector layer 108 include a carbon material; an electrically conductive polymer; a noble metal such as Au, Pt and Pd; a metal other than the noble metal such as Ti, Ta, W, Nb, Ni, Al, Cr, Ag, Cu, Zn and Su; Si; a nitride, a carbide, and a carbonitride of these metals; an alloy such as stainless steel, Cu—Cr, Ni—Cr, Ti—Pt and the like. More preferably, the material constituting the anode collector layer includes at least one element selected from the group consisting of Pt, Ti, Au, Ag, Cu, Ni and W. The inclusion of such elements reduces the specific resistance of the anode collector layer, which in turn alleviates reduction in the voltage caused by the resistance of the anode collector layer. Thus, a higher power generation property can be achieved. In the case where a metal having poor corrosion resistance under an acidic atmosphere such as Cu, Ag, or Zn is used, a coat of a noble metal having corrosion resistance such as Au, Pt, Pd, another metal having corrosion resistance, an electrically conductive polymer, an electrically conductive nitride, an electrically conductive carbide, an electrically conductive carbonitride, an electrically conductive oxide or the like may be applied to the surface. Accordingly, the lifetime of the fuel cell can be lengthened.

Fuel flow channel 109 is a flow passage for supplying fuel to anode catalyst layer 103. The shape of the fuel flow channel is not particularly limited. For example, the cross section thereof may take a rectangular shape, as shown in FIG. 1. Fuel flow channel 109 can be provided by forming one or more grooves at the surface of anode collector layer 108 facing anode gas diffusion layer 105. The fuel flow channel has a width of preferably 0.1 to 1 mm, and a cross sectional area of preferably 0.01 to 1 mm². The width and the cross sectional area of the fuel flow channel are preferably determined taking into account the electrical resistance of anode collector layer 108 and the contacting area between anode collector layer 108 and anode gas diffusion layer 105.

In the present embodiment, anode collector layer 108 has a pair of linear first walls 120 provided along two opposite sides. A recess is formed at the surface of anode collector layer 108 by the pair of first walls 120. Fuel flow channel 109 is located at the bottom plane of the recess. Membrane electrode assembly 107 is fitted into the recess, so that a portion of the side face of anode gas diffusion layer 105 forms contact with the inner sidewall face of first wall 120 of anode collector layer 108. The fitting of membrane electrode assembly 107 into the recess of anode collector layer 108 facilitates alignment between membrane electrode assembly 107 and anode collector layer 108 in the fabrication process. Thus, the fabrication cost can be reduced by simplifying the fabrication process of the fuel cell. In the case where second wall 116 is provided on first wall 120, as will be described later, second wall 116 can be disposed with a predetermined distance from membrane electrode assembly 107 in high accuracy. Therefore, a space between membrane electrode assembly 107 and second wall 116 can be uniformly filled with an insulative sealing layer 114. Accordingly, fuel leakage and oxidant leakage can be further suppressed.

A thickness of the portion of anode collector layer 108 in contact with the side face of membrane electrode assembly 107 (that is, a height of first wall 120 or a depth of the recess) is preferably set less than or equal to the total thickness of electrolyte membrane 102, anode catalyst layer 103, and anode gas diffusion layer 105. Accordingly, contact between second wall 116 and the cathode electrode can be avoided suitably to prevent electrical shorting.

<Second Wall>

On the pair of linear first walls 120 of anode collector layer 108, linear second wall 116 is preferably provided. Second wall 116 is arranged on first wall 120 so that a gap space is formed between a side face of membrane electrode assembly 107 and a side face of second wall 116 facing the side face of membrane electrode assembly 107. Insulative sealing layer 114 that will be described afterwards is preferably formed in this gap space.

For the material of second wall 116, an electron conductive material can be used. The usage of the electron conductive material allows second wall 116, in addition to anode collector layer 108, to function as an anode collector layer, thus suppressing reduction in power generation caused by voltage reduction resulting from lower resistance value. For the electron conductive material, a material similar to that of anode collector layer 108 can be preferably used. Examples of the electron conductive material include a carbon material; an electrically conductive polymer; a noble metal such as Au, Pt and Pd; a metal other than the noble metal such as Ti, Ta, W, Nb, Ni, Al, Cr, Ag, Cu, Zn and Su; Si; a nitride, a carbide, and a carbonitride of these metals; an alloy such as stainless steel, Cu—Cr, Ni—Cr, Ti—Pt and the like. More preferably, the material constituting the second wall includes at least one element selected from the group consisting of Pt, Ti, Au, Ag, Cu, Ni and W. In the case where a metal having poor corrosion resistance under an acidic atmosphere such as Cu, Ag, or Zn is used, a coat of a noble metal having corrosion resistance such as Au, Pt, Pd, another metal having corrosion resistance, an electrically conductive polymer, an electrically conductive nitride, an electrically conductive carbide, an electrically conductive carbonitride, an electrically conductive oxide or the like may be applied to the surface.

For the material employed for second wall 116, it is more preferable to use an electron insulative material. Accordingly, electrical shorting can be prevented even if both the anode electrode and cathode electrode of membrane electrode assembly 107 form contact with second wall 116. Examples of the insulative material preferably employed include an organic polymer material such as acrylic resin, ABS resin, polyimide resin, Teflon (registered trademark) resin, silicone resin and the like. More preferably, acrylic resin or ABS resin having favorable adherence with insulative sealing layer 114 that will be described afterwards is used. By increasing the binding force with the insulative sealing layer, the possibility of detachment between second wall 116 and the insulative sealing layer is eliminated. Thus, leakage of fuel and introduction of the oxidant to the anode electrode can be suppressed more effectively, and the reliability of the fuel cell can be increased.

Second wall 116 is formed so as to provide a predetermined gap space between second wall 116 and membrane electrode assembly 107 for introducing insulative sealing layer 114. A width of second wall 116 is not particularly limited as long as a gap space for introducing insulative sealing layer 114 is formed between second wall 116 and membrane electrode assembly 107. Although a thickness of second wall 116 is not particularly limited as long as a space for introducing insulative sealing layer 114 can be provided between second wall 116 and cathode collector layer 113, durability against vibration in a direction perpendicular to a direction of the layer thickness can be increased by minimizing the space between second wall 116 and cathode collector layer 113 where insulative sealing layer 114 is to be introduced. Accordingly, the structure of the fuel cell and fuel cell layer can be enforced.

Although the configuration of second wall 116 is not particularly limited as long as the space for introducing insulative sealing layer 114 can be provided between second wall 116 and membrane electrode assembly 107, the cross sectional shape of second wall 116 is preferably a rectangle, as shown in FIG. 1. In this case, the side face of membrane electrode assembly 107 and the side face of second wall 116 facing membrane electrode assembly 107 is parallel, or approximately parallel.

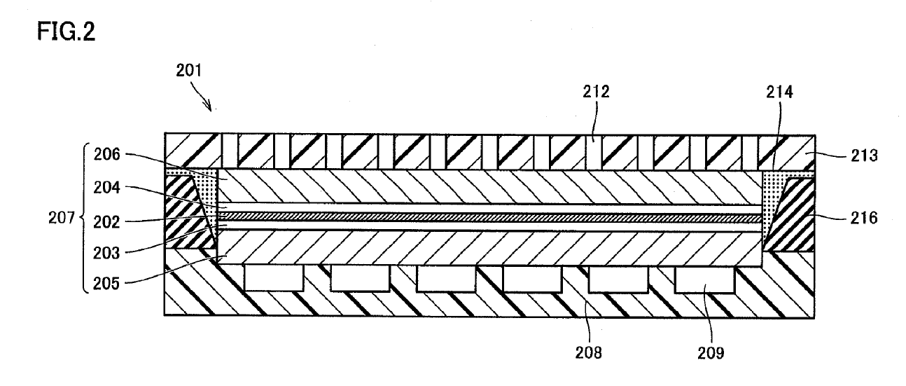

The cross sectional shape of the second wall is more preferably a triangle, or a pentagon, or a trapezoid like a second wall 216 shown in FIG. 2. In this case, the side face of the second wall facing the membrane electrode assembly is inclined with respect to the side face of membrane electrode assembly 107, or has an inclined face with respect to the same. Such a configuration causes increase in the contacting area between the second wall and the insulative sealing layer, allowing the binding force to be increased. Therefore, fuel leakage and introduction of an oxidant to the anode electrode caused by detachment at the joining region can be suppressed further effectively.

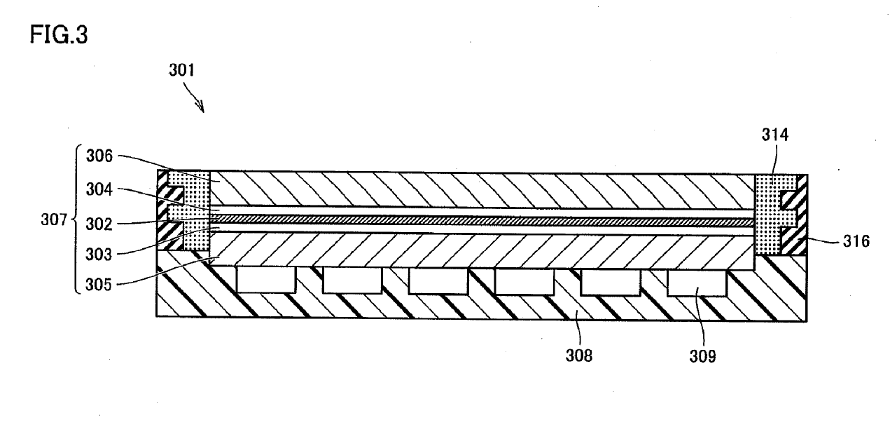

Referring to FIG. 3, the side face of a second wall 316 facing membrane electrode assembly 307 (the side face in contact with insulative sealing layer 314) may have a recess and a projection. Thus, the contacting area between second wall 316 and insulative sealing layer 314 is increased to further secure the adherence between the two layers. Therefore, deviation of the arrangement in the stacked direction of membrane electrode composite 307 and insulative sealing layer 314 can be avoided even when a fuel cell does not have a cathode collector layer like a fuel cell 301, allowing electric power to be supplied stably. Moreover, the number of components for the fuel cell can be reduced to lower the fabrication steps and fabrication cost. In addition, leakage of fuel and introduction of the oxidant to the anode electrode can be suppressed further effectively.

The second wall may be formed integrally with the anode collector layer by processing the base material constituting the anode collector layer through etching, cutting, or the like, likewise with the first wall. Alternatively, the second wall formed as a distinct member from the anode controller layer having the first wall may be coupled to the first wall of the anode collector layer. In the former case, durability against the force in a direction perpendicular to the stacked direction is improved. In addition, durability against towards bending stress is also improved. Accordingly, the structure of the fuel cell and fuel cell layer can be enforced. In the latter case, the material for the second wall can be selected without being influenced by the material for the anode collector layer. Accordingly, the cost for manufacturing a fuel cell can be reduced by selecting an economic material. Further, the adherence to the insulative sealing layer can be improved.

<Cathode Collector Layer>

Cathode collector layer 113 functions to transmit/receive electrons to/from cathode gas diffusion layer 106, and includes a through hole 112 for communication between the outside of the fuel cell and cathode gas diffusion layer 106. Since the cathode collector layer is generally maintained at a potential higher than that of the anode collector layer during power generation of the fuel cell, the material for the cathode collector layer preferably should have a corrosion resistance of a level equal to or greater than that of the anode collector layer.

The material for cathode collector layer 113 may be identical to that of anode collector layer 108. In particular, it is preferable to use a carbon material; an electrically conductive polymer; a noble metal such as Au, Pt, Pd, a metal other than the noble metal such as Ti, Ta, W, Nb, Cr; a nitride and a carbide of these metals; an alloy such as stainless steel, Cu—Cr, Ni—Cr, Ti—Pt, or the like. In the case where a metal having poor corrosion resistance under an acidic atmosphere such as Cu, Ag, Zn, Ni is used, a coat of a noble metal having corrosion resistance, another metal having corrosion resistance, an electrically conductive polymer, an electrically conductive oxide, an electrically conductive nitride, an electrically conductive carbide, an electrically conductive carbonitride or the like may be applied to the surface.

A shape of cathode collector layer 113 is not particularly limited as long as oxygen in the air can be introduced into cathode gas diffusion layer 106. In the case where cathode collector layer 113 of fuel cell 101 is greatly exposed to the atmosphere, and the concentration of the oxygen around cathode collector layer 113 does not decrease significantly even during operation of fuel cell 101, cathode collector layer 113 preferably includes a plurality of through holes 112 extending in the direction of the layer thickness. Accordingly, the oxygen can be introduced efficiently from the air through the least number of through holes 112, and reduction in the volume of cathode collector layer 113, i.e. increase in the electric resistance, can be suppressed. This leads to suppressing reduction in the potential at cathode collector layer 113, allowing electric power to be supplied stably.

In the case where a plurality of fuel cells 101 constitute a stacked structure, layered in the thickness direction, cathode collector layer 113 preferably includes a plurality of through holes extending in the direction of the plane, in addition to the plurality of through holes extending in the layer thickness direction. Accordingly, in a stacked structure where an anode collector layer of a second fuel cell is stacked close to a cathode collector layer of a first fuel cell, oxygen in air can be introduced into a cathode gas diffusion layer of the first fuel cell through the through holes extending in the plane direction, provided at a side face of the cathode collector layer.

Examples of cathode collector layer 113 of the above-described shape include foam metal, metal fabric, sintered metal, carbon paper, carbon cloth and the like. In a fuel cell 101 of the present invention, cathode collector layer 113 may be omitted.

<Insulative Sealing Layer>

Insulative sealing layer 114 is formed by filling the gap space located between membrane electrode assembly 107, cathode collector layer 113, and second wall 116 with an insulative sealant. By forming insulative sealing layer 114 at the gap space provided between membrane electrode assembly 107, cathode collector layer 113 and second wall 116, the adherence between members constituting the fuel cell is improved to prevent fuel leakage from the side face of membrane electrode assembly 107 and introduction of an oxidant from the side face of membrane electrode assembly 107 to the anode electrode. Further, by forming insulative sealing layer 114 to fill the gap space provided between membrane electrode assembly 107, cathode collector layer 113 and second wall 116 in a fuel cell layer having a plurality of fuel cells arranged apart, or having a plurality of fuel cells so that a gap region is formed between fuel cells, the running of the insulative sealant from the side face of fuel cell 101 can be prevented in the filling step of the insulative sealant. As such, a region for diffusing an oxidant provided between adjacent fuel cells (the gap region provided between fuel cells) can be ensured in high accuracy. Thus, there can be provided a fuel cell and fuel cell layer allowing stable supply of electric power.

The insulative sealant employed for insulative sealing layer 114 prefereably contains a hydrophobic polymer material. The usage of an insulative sealant of such a material can prevent fuel leakage over a long period of time since swelling, hydrolysis, or the like by methanol solution fuel does not readily occur. The insulative sealant preferably consists of a material having high adherence with respect to membrane electrode assembly 107, cathode collector layer 113, and second wall 116.

Examples of a specific material employed for the insulative sealant include fluorine-containing resin, fluorine-containing rubber, fluorine based surface finishing agent, silicon-containing resin, silicon-containing rubber, epoxy based resin, olefin based resin, polyamide based resin, and the like.

By providing insulative sealing layer 114 between second wall 116 and membrane electrode assembly 107 that allows adherence between each of the constituent members in a fuel cell of the above-described configuration, durability against vibration is increased so that electric power can be supplied stably.

### Second Embodiment

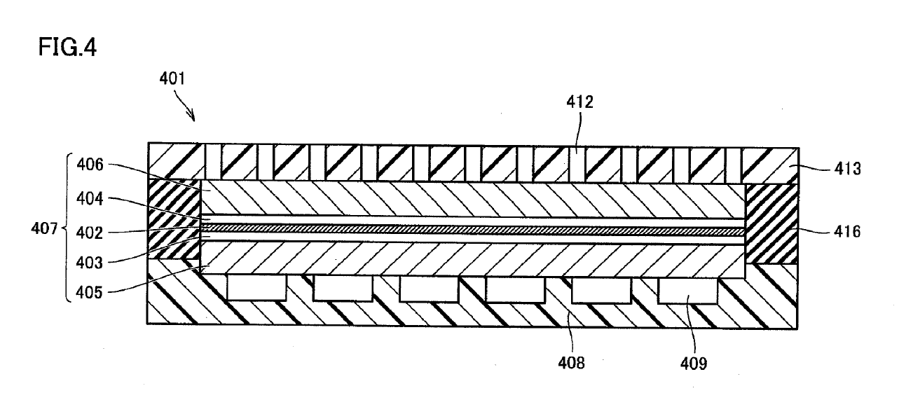

FIG. 4 is a sectional view schematically representing another preferable example of a fuel cell of the present invention. A fuel cell 401 of FIG. 4 includes a second wall 416, between an anode collector layer 408 and a cathode collector layer 413, and in contact with a membrane electrode assembly 407. Second wall 416 is a layer formed of a porous material in which micropores are filled with an insulative sealant. In other words, second wall 416 is coupled to the side face of the membrane electrode assembly without the provision of a gap space between the second wall and the membrane electrode assembly, differing from the first embodiment set forth above. In the present embodiment, second wall 416 also functions as the aforementioned insulative sealing layer. The remaining configuration is similar to that of the first embodiment.

By employing a second wall of the above-described configuration, advantages similar to those of the first embodiment can be achieved. Further, since most of the side face of membrane electrode assembly 407 is arranged in contact with second wall 416, the alignment between the membrane electrode assembly and the anode collector layer is facilitated in the fabrication process, allowing the fabrication cost to be reduced by simplifying the fabrication steps of the fuel cell.

### EXAMPLES

The present invention will be described in further detail based on examples. It is to be understood that the present invention is not limited to these examples.

### Example 1

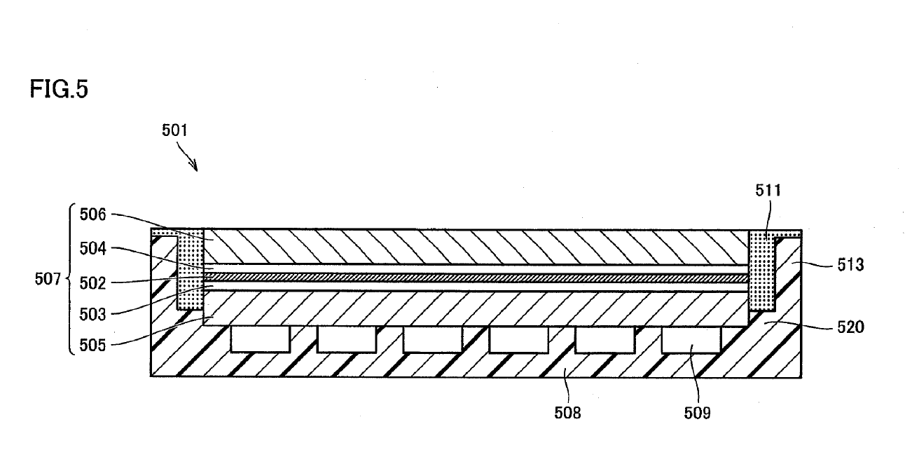

A fuel cell 501 having the structure shown in FIG. 5 was fabricated as set forth below. For an electrolyte membrane 502, Nafion (registered trademark) 117 (from E.I. du Pont de Nemours & Co.) of 40×40 mm and having a thickness of approximately 175 μm was employed.

Catalyst pastes were prepared by the procedures set forth below. Catalyst-supported carbon particles formed of Pt particles, Ru particles and carbon particles, having a Pt content of 32.5 wt % and a Ru content of 16.9 wt % (TEC66E50, from TANAKA KIKINZOKU KOGYO K.K.), an alcohol solution of 20 wt % Nafion (from Aldrich), ion-exchanged water, isopropanol, and zirconia beads were placed in a PTFE vessel at a predetermined ratio. These ingredients were mixed for 50 minutes at 500 rpm using a stirrer, followed by removing the zirconia beads to prepare a catalyst paste for an anode. In addition, a catalyst paste for a cathode was prepared under conditions similar to those of preparing the catalyst paste for an anode, using catalyst-supported carbon particles formed of Pt particles and carbon particles, having a Pt content of 46.8 wt % (TEC10E50E, from TANAKA KIKINZOKU KOGYO K.K.).

The anode catalyst paste was applied to the center on one surface of Nafion 117 that is the electrolyte membrane using a screen-printing plate having a window of 23×23 mm such that the catalyst content is 2 mg/cm². Then, drying was performed at room temperature to form an anode catalyst layer 503 having a thickness of approximately 30 μm. Similarly, the catalyst paste for a cathode was applied to the center on the other surface of the Nafion 117 at a position corresponding to anode catalyst layer 503 to perform screen-printing in a manner similar to that described above such that the catalyst content is 3 mg/cm². Then, drying was performed at room temperature to form a cathode catalyst layer 504 having a thickness of approximately 20 μm. Hereinafter, Nafion 117 having anode catalyst layer 503 and cathode catalyst layer 504 formed is referred to as CCM (Catalyst Coated Membrane).

For an anode gas diffusion layer 505 and a cathode gas diffusion layer 506, two sheets of carbon paper GDL25BC (from SGL CARBON JAPAN Co., Ltd) having a water-repellant layer at one surface were cut to a size of 23×23 mm.

The CCM was superimposed on the water-repellant layer of the carbon paper such that the anode catalyst layer of the CCM is consistent with the carbon paper. Then, the other carbon paper qualified as cathode gas diffusion layer 506 was superimposed thereon such that the cathode catalyst layer of the CCM is consistent with the carbon paper. A stainless steel spacer of 600 μm in thickness was arranged along the perimeter of the CCM with respective members still superimposed. A hot press treatment was performed for two minutes at 130° C. and 10 kN to integrate each of the members to form a membrane electrode assembly.

The obtained membrane electrode assembly was sandwiched with polyethylene films and was cut to the size of 11 mm×21 mm by pressing a trimming knife perpendicularly while being held down by means of a plastic plate to obtain a membrane electrode assembly 507. Each of the constituent layer formed the same cross section at all the four sides of membrane electrode assembly 507.

An anode collector layer 508 was produced as set forth below. A flat plate of acid-resistant stainless steel having an outer shape of 14 mm×30 mm and a thickness of 500 μm was etched to have a groove of 300 μm in depth and 13 mm in width dug in the longitudinal direction. Thus, a linear second wall 513 of 500 μm in width was formed at both sides in the longitudinal direction of the anode collector layer. Then, a groove (recess) of 100 μm in depth and 11 mm in width was dug in the longitudinal direction, resulting in an anode collector layer having first wall 520 and second wall 530 formed in the longitudinal direction. First wall 520 had a width of 1.5 mm, on which second wall 513 having a width of 500 μm was formed. Further by etching, grooves of 100 μm in depth and 2 mm in width were formed in the longitudinal direction at the pitch of 1 mm, identified as fuel flow channels 509. Thus, anode collector layer 508 was obtained.

The obtained membrane electrode assembly 507 was fitted in the recess of anode collector layer 508. Epoxy resin was applied and spread into the gap space between the side face of membrane electrode assembly 507 and second wall 513 to obtain insulative sealing layer 511.

Then, a silicon tube having an outer diameter of 2.5 mmφ (inner diameter 1.5 mmφ) (product of Tech-Jam Co., Ltd. ST1.5-2.5) identified as a fuel supply tube had a cut of 15 mm length formed in the longitudinal direction. The fuel cell was inserted in the cut so that the side face of the fuel cell where the end of the anode collector layer is open was inserted as far as the central region of the tube. The gap was filled with a sealant of silicon resin, followed by drying to form a connection portion of fuel supply. Thus, fuel cell 501 was obtained.

3M methanol aqueous solution was supplied at the rate of 0.5 ml/min. using a diaphragm pump to the obtained fuel cell 501. It was confirmed that the fuel was not leaking during the supply of the fuel.

### Comparative Example 1

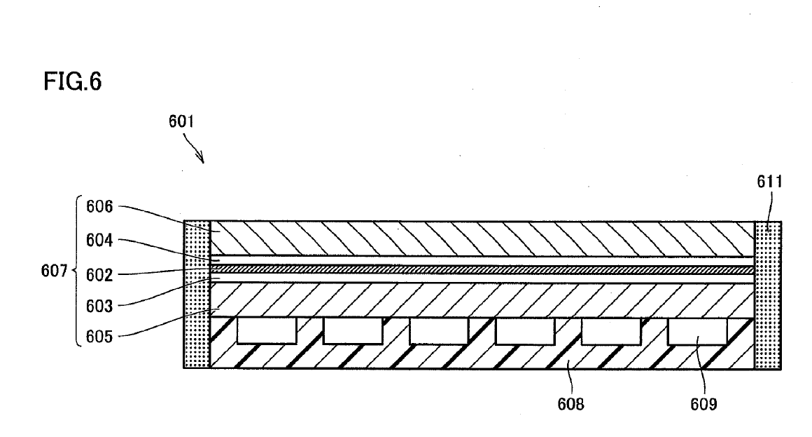

A fuel cell 601 having the structure shown in FIG. 6 was fabricated as set forth below. Membrane electrode assembly 607 was fabricated in a manner similar to that of Example 1. An anode collector layer 608 was produced as set forth below. A flat plate of acid-resistant stainless steel having an outer shape of 11 mm×30 mm and a thickness of 200 μm was etched to dig grooves of 100 μm in depth and 2 mm in width at the pitch of 1 mm, resulting in fuel flow channels 609. Thus, anode collector layer 608 was obtained.

The obtained membrane electrode assembly 607 was arranged on anode collector layer 608. Epoxy resin was applied and spread as thin as possible to both side faces formed by membrane electrode assembly 607 and anode collector layer 608 to form an insulative sealing layer 611. A fuel supply tube was attached in a manner similar to that of Example 1 to obtain fuel cell 601.

3M methanol aqueous solution was supplied at the rate of 0.5 ml/min. using a diaphragm pump to the obtained fuel cell 601. During the supply of the fuel, fuel leakage was identified visually.

It should be understood that the embodiments and examples disclosed herein are illustrative and non-restrictive in every respect. The scope of the present invention is defined by the terms of the claims, rather than the description above, and is intended to include any modification within the scope and meaning equivalent to the terms of the claims.

### DESCRIPTION OF THE REFERENCE SIGNS

101, 201, 301, 401, 501, 601 fuel cell; 102, 202, 302, 402, 502, 602 electrolyte membrane; 103, 203, 303, 403, 503, 603 anode catalyst layer; 104, 204, 304, 404, 504, 604 cathode catalyst layer; 105, 205, 305, 405, 505, 605 anode gas diffusion layer; 106, 206, 306, 406, 506, 606 cathode gas diffusion layer; 107, 207, 307, 407, 507, 607 membrane electrode assembly; 108, 208, 308, 408, 508, 608 anode collector layer; 109, 209, 309, 409, 509, 609 fuel flow channel; 112, 212, 412 through hole; 113, 213, 413 cathode collector layer; 114, 214, 314, 511, 611 insulative sealing layer; 116, 216, 316, 416, 513 second wall; 120, 520 first wall.

1-11. (canceled)

12. A fuel cell comprising:
a membrane electrode assembly including a cathode electrode, an electrolyte membrane, and an anode electrode in this order, and
an anode collector layer,
said anode collector layer including a pair of first walls provided along two opposite sides, and a pair of second walls formed on said pair of first walls,
said membrane electrode assembly being fitted between the first walls such that said anode electrode faces said anode collector layer.

13. The fuel cell according to claim 12, including a gap space between said membrane electrode assembly and said second wall.

14. The fuel cell according to claim 13, wherein said gap space is filled with an insulative sealant.

15. The fuel cell according to claim 13, wherein a side face of said membrane electrode assembly and a side face of said second wall facing said membrane electrode assembly are substantially parallel.

16. The fuel cell according to claim 13, wherein a side faces of said second wall facing said membrane electrode assembly is inclined with respect to a side face of said membrane electrode assembly.

17. The fuel cell according to claim 13, wherein a side face of said second wall facing said membrane electrode assembly has a recess and a projection.

18. The fuel cell according to claim 12, wherein said second wall is formed of an electrically insulative material.

19. The fuel cell according to claim 12, wherein said second wall is formed of a porous material including an insulative sealant, arranged in contact with a side face of said membrane electrode assembly.

20. The fuel cell according to claim 12, wherein said second wall is formed integrally with said anode collector layer.

21. A fuel cell layer having a plurality of the fuel cells defined in claim 12 disposed with a gap region.
